(19) United States
(12) Patent Application Publication
(10) Pub. No.: US 2004/0033093 A1
(43) Pub. Date: Feb. 19, 2004

(54) Pressure roller with profiled core for better paper handling

(75) Inventors: Fangsheng Wu, Rochester, NY (US); Muhammed Aslam, Rochester, NY (US); Robert D. Bobo, Ontario, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/219,586

(22) Filed: Aug. 15, 2002

(51) Int. Cl. G03G 15/20

(52) U.S. Cl. 399/333

(57) ABSTRACT

A fuser assembly for a reproduction apparatus. The fuser assembly includes a fuser roller and a pressure roller associated therewith in nip relation. At least on of the rollers have a profiled core and a base cushion applied to the profiled core to provide for uniform drive speed through the nip across the roller.

### FIELD OF THE INVENTION

This invention relates in general to fuser assemblies for reproduction apparatus, and more particularly to a reproduction apparatus fuser assembly having a roller with a profiled core to improve receiver sheet handling.

### BACKGROUND OF THE INVENTION

In typical commercial reproduction apparatus (electrostatographic copier/duplicators, printers, or the like), a latent image charge pattern is formed on a uniformly charged dielectric member. Pigmented marking particles are attracted to the latent image charge pattern to develop such image on the dielectric member. A receiver member (e.g., paper or transparency material) is then brought into contact with the dielectric member. An electric field, such as provided by a corona charger or an electrically biased roller, is applied to transfer the marking particle developed image to the receiver member from the dielectric member. After transfer, the receiver member bearing the transferred image is separated from the dielectric member and transported away from the dielectric member to a fuser assembly at a downstream location. There the image is fixed to the receiver member by heat and/or pressure from the fuser assembly to form a permanent reproduction on the receiver member.

One common type of fuser assembly includes a fuser roller and a pressure roller associated in a nip relation. The fuser roller and pressure roller usually have a metal core, a rubber base cushion, and one or more layers of very thin top coatings for surface coating or toner offset prevention. One of the defects that this type of fuser assembly may be subject to is paper-handling problems which can result in wrinkles and/or image smearing. Such problems are caused by uneven driving speed, across paper width, through the fuser roller nip. If the driving speed at the center of the nip is faster than that at the two ends, wrinkles may occur. If the driving speed at the center of the nip is slower that that at the two ends, image smear or even paper tear may occur. If the speed difference is not strong enough to overcome paper strength to produce wrinkles or slap-ups (paper snapping under lateral tension), toner disturbances may appear instead. The factors, which can cause uneven driving speed, include uneven diameter of the rollers, uneven thermal expansion of the rollers, uneven distribution of the toner, or any combination of the above.

In the prior art, in order to solve paper-handling problems, two general methods have been tried. With the first method, a torque is applied at the two ends of the fuser assembly pressure roller to bend such roller. The principle shortcoming of this method is that the needed torque is quite high, especially when the roller diameter is big, and thus the required mechanism is complex and expensive. With the second method, a concave profiled base cushion is utilized. The required concave profile is normally small; for example, in the range of a few microns. This requires tight dimensional tolerance control, and thus high production cost. The non-straight base cushion surface makes the top coating process more difficult. The roller surface is also non-straight, which may adversely affect the function of other parts of the fuser assembly, or associated elements such as a roller cleaner or oiler.

### SUMMARY OF THE INVENTION

In view of the above, this invention is directed to a fuser assembly construction which can reduce the paper-handling problem. The fuser assembly includes a fuser roller and a pressure roller associated therewith in nip relation. At least on of the rollers have a profiled core and a base cushion applied to the profiled core to provide for uniform drive speed through the nip across the roller.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 is a side view, in cross-section, of the rollers of a typical reproduction apparatus fuser assembly; and

FIG. 2 is a front view, in cross-section, of the rollers of a typical reproduction apparatus fuser assembly, with a profiled pressure roller according to this invention, with portions removed to facilitate viewing.

### DETAILED DESCRIPTION OF THE INVENTION

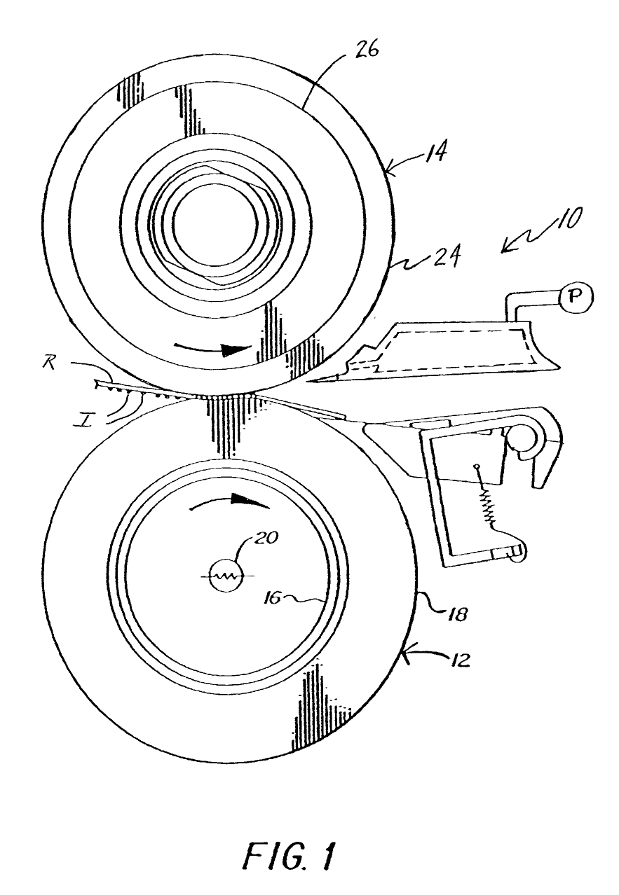

Referring now to the accompanying drawings, FIG. 1 shows a typical fuser assembly, designated generally by the numeral 10, for a common commercial electrographic reproduction apparatus. The fuser assembly 10 includes a fuser roller 12 in nip relation with a pressure roller 14. Rotation of the fuser rollers by any suitable drive mechanism (not shown) will serve to transport a receiver member (designated for example by the letter R in FIG. 1), bearing a marking particle image I, through the nip under the application of heat and pressure. The receiver member may be, for example, a sheet of plain bond paper, or transparency material. The heat will soften the marking particles and the pressure will force the particles into intimate contact with each other and with the surface of the receiver material, such that the particles are at least partially imbibed into the receiver material fibers. Thus, when the marking particles cool, they are permanently fixed to the receiver member in an image-wise fashion.

The fuser roller 12 includes a core 16 with a cylindrical fusing blanket 18 supported on the core. The blanket 18 is typically made of a rubber material particularly formulated to be heat conductive or heat insulative depending upon whether the fuser heat source is located within the core 16 or in juxtaposition with the periphery of the blanket. In the illustrated preferred embodiment as shown in FIG. 1, the heat source is an internal heater lamp designated by the numeral 20. A well known suitable surface coating (not shown) may be applied to the blanket 18 to substantially prevent offsetting of the marking particle image to the fuser roller 12.

The pressure roller 14 has a base cushion 24, which may also have a well-known suitable surface coating (not shown) applied thereto, substantially prevent offsetting of the marking particle image to the pressure roller 14. The base cushion 24 is supported on a rigid core 26, made from aluminum or steel for example. Further, a cleaning assembly (not shown) may be provided to remove residual marking particle, paper fibers, and dust from the fuser apparatus rollers.

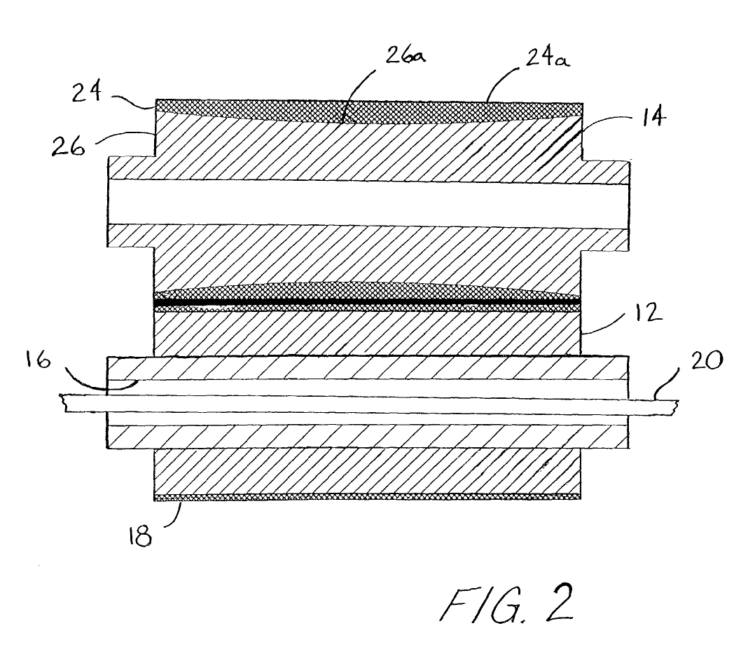

According to this invention, in order to achieve paper handling improvement for the fuser assembly 10, the pressure roller 14 has had the core 26 profiled with a shape 26a generally in the form of an hourglass or smile (see FIG. 2). Then the base cushion 24 is put on the core 26 by injection molding or other suitable methods. The outer peripheral surface 24a of the base cushion 24 is formed so as to be substantially straight. Thereafter, any particular desired top coating can then be applied on the base cushion by any normal method. The shape 26a of the pressure roller core profile can be as shown in FIG. 2, or alternatively can be V-shaped, or have other gradually changing shapes. Of course, with other well-known fuser assembly embodiments, the fusing roller may be the roller having the profiled core.

The diameter difference between the center and the two ends of the core 26 can vary, depending on the specific fuser assembly. Generally, the difference in diameter from the ends to the center of the pressure roller ranges from 0.5 mm to 4.0 mm.

As discussed above, when the pressure roller14 is engaged with the fuser roller 12, a nip is formed therebetween. Since the thickness of the base cushion 24 of the pressure roller changes from the center to the ends, the strain in the pressure roller base cushion also changes accordingly. This differential strain gives desired driving speed differentials. That is, the driving speed across the pressure roller 14, through the fuser assembly nip, is established as being substantially even. The paper handling of the fuser assembly 10 is thus improved.

The particular advantages of the profiled pressure roller, according to this invention, are that since the profile is on the core 26, it is easier for machining (e.g., easier than machining a rubber coating). With easier machining, the requirements for tolerance control are also eased, and the top-coating process becomes more readily accomplished. Accordingly, the cost of the fuser assembly is substantially reduced. Furthermore, the straightness of the pressure roller surface results in substantially no adverse effects on functioning of other parts of the fuser assembly.

The invention has been described in detail with particular reference to certain preferred embodiments thereof, but it will be understood that variations and modifications can be effected within the spirit and scope of the invention.

What is claimed is:

1. A fuser assembly for a reproduction apparatus, said fuser assembly comprising:
a fuser roller and a pressure roller associated therewith in nip relation, at least on of said rollers having a profiled core and a base cushion applied to said profiled core to provide for uniform drive speed through said nip across said roller.

2. The fuser assembly of claim 1, wherein said at least one roller is said pressure roller.

3. The fuser assembly of claim 2, wherein the profiled core is in the form of an hourglass or smile.

4. The fuser assembly of claim 3, wherein difference in diameter from the ends to the center of the pressure roller ranges from 0.5 mm to 4.0 mm.

5. The fuser assembly of claim 2, wherein the profiled core is V-shaped.

6. The fuser assembly of claim 2, wherein the profiled core is of a gradually changing shape.

7. The fuser assembly of claim 1, wherein said base cushion is put on by injection molding or the like.

8. The fuser assembly of claim 7, wherein the outer peripheral surface of said base cushion is substantially straight.
